(19) United States
(12) Patent Application Publication
(10) Pub. No.: US 2014/0176566 A1
(43) Pub. Date: Jun. 26, 2014

(54) APPARATUS FOR SIMULTANEOUSLY STORING AREA SELECTED IN IMAGE AND APPARATUS FOR CREATING AN IMAGE FILE BY AUTOMATICALLY RECORDING IMAGE INFORMATION

(71) Applicant: SAMSUNG ELECTRONICS CO., LTD., Suwon-si (KR)

(72) Inventor: Soo-Ho CHO, Seoul (KR)

(73) Assignee: SAMSUNG ELECTRONICS CO., LTD., Suwon-si (KR)

(21) Appl. No.: 14/191,216

(22) Filed: Feb. 26, 2014

Related U.S. Application Data
(62) Division of application No. 11/782,291, filed on Jul. 24, 2007, now abandoned.

(30) Foreign Application Priority Data
Nov. 23, 2006 (KR) 10-2006-0116564

(51) Int. Cl. G06T 13/00

(52) U.S. Cl. CPC G06T 13/00
USPC 345/473

(57) ABSTRACT

An apparatus to collectively store areas selected in an image includes an image-editing unit to load a standard image file, to display a standard image based on the standard image file, and to enable a user to edit the standard image, a zooming unit to zoom into and away from a position where a marker of an input unit is indicating on the standard image, and a selected-image-managing unit to collectively store one or more areas selected by the input unit as one or more corresponding image files.

### CROSS-REFERENCE TO RELATED APPLICATION

This application is a Divisional Application of U.S. application Ser. No. 11/782,291, filed Jul. 24, 2007, which claims the benefit under 35 U.S.C. §119(a) of Korean Application No. 10-2006-0116564 filed on Nov. 23, 2006, in the Korean Intellectual Property Office, the disclosures of which are incorporated herein by reference in their entireties.

### BACKGROUND OF THE INVENTION

1. Field of the Invention

Aspects of the present invention relate to an apparatus for collectively storing areas selected in an image and an apparatus for creating an image file, and more particularly, to an apparatus for collectively storing areas selected in an image which improves efficiency by collectively storing selected areas in an image and an apparatus for creating an image file which efficiently and easily creates an image file having metadata of the image.

2. Description of the Related Art

Images that constitute graphical user interfaces (GUI) are implemented in electronic products, such as cellular phones and personal digital assistants (PDAs), and are designed by designers. After the images are designed, the designers send the images to software developers in order to implement the images in the electronic products. Generally, the designer designs a screen which includes an entire image of products. However, when the software developers implement the entire image designed by the designer, the entire image is divided into pieces based on each element within the image.

FIGS. 1(a) and 1(b) depict a process of producing a graphical user interface (GUI) image and subdividing the image. The image 10 shown in FIG. 1(a) is an example of an image designed by designers. FIG. 1(b) illustrates how the image 10 is divided into pieces 20 based on each element within the image 10 when the image 10 is sent to software developers.

Accordingly, each element within the image 10 is divided and stored as elements. Conventionally, the processes of setting boundaries of the divided area around an element, copying the divided area to a new document, generating a filename for the area, and storing the area are repeated for each element, which is inefficient. Also, errors may occur when the divided area is selected, such as, for example, setting the boundaries around an element in an improper fashion.

Furthermore, when the image 10 and the pieces 20 are sent to software developers, image metadata, such as, for example, the positions of the pieces 20 in relation to the image 10, the colors of the pieces 20, the filenames of the pieces 20, and the sizes of the pieces 20 are sent to software developers using a general document generator, such as, for example, a word processor. FIG. 2 depicts an example of a process to create an image file of a GUI image 30. When the GUI image 30 is produced by designers, the GUI image 30 is sent to the software developers as a document in which design information 40, such as, for example, a size, a font, a background color, or various types of requests by the designers, is recorded within the GUI image 30. An image file to store the design information 40 is created by individually typing each type of the design information 40 into the image file, which is an inefficient and time-consuming process.

### SUMMARY OF THE INVENTION

Several aspects and example embodiments of the present invention provide an apparatus and method to efficiently store selected areas of an entire image, thereby improving the efficiency of an image division process.

Other aspects of the present invention relate to an apparatus and method to automatically store image information based on metadata stored in an image when image files are created, which also improves the efficiency of the process of storing image information.

Additional aspects and/or advantages of the invention will be set forth in part in the description which follows and, in part, will be obvious from the description, or may be learned by practice of the invention.

In accordance with an example embodiment of the present invention, an apparatus to collectively store areas selected from a standard image is provided with an image-editing unit to loads a standard image file, to display a standard image based on the standard image file, and to enable a user to edit the standard image; a zooming unit to zoom into and away from a position where an input unit is indicating on the standard image; and a selected-image-managing unit to collectively store one or more areas selected by the input unit as one or more corresponding image files.

According to an aspect of the present invention, an image-file-creating apparatus includes an image-loading unit to load an image file having a plurality of types of metadata and to display an image based on the image file; an image-information-selecting unit to select at least one type of the metadata from the image; and an image-information-displaying unit to automatically display the at least one selected type of metadata.

According to another aspect of the present invention, an image-file-creating apparatus includes an image-table-loading unit to load an image table in which metadata of one or more images is recorded; an image-file-loading unit to load one or more image files corresponding to the one or more images and having the metadata of the one or more images; and an image-information-inputting unit to input the metadata of the one or more image files in cells of the image table.

According to another aspect of the present invention, an image-file-creating apparatus includes an animation-table-loading unit to load metadata of one or more images and an animation table where a display time of the one or more images is recorded; an image-file-loading unit to load one or more image files which correspond to the one or more images and which include the metadata; and an image-information-inputting unit to input the metadata of the one or more image files cells of the image table.

According to another aspect of the present invention, an image-file-creating apparatus includes an indicator-table-loading unit to load an indicator table which displays images, wherein each of the images is located in a corresponding position and changes appearance according to a condition; an image-file-loading unit to load one or more image files which correspond to the images and which have metadata of the images; and an indicator-displaying unit to automatically arrange the images indicated as being in a same position.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIGS. 1(a) and 1(b) depict a process of producing a graphical user interface (GUI) image and subdividing the image;

FIG. 2 depicts a process of creating an image file of a GUI image;

FIG. 3 is a block diagram of an apparatus to collectively store areas selected on an image according to an example embodiment of the present invention;

FIG. 4 depicts a user interface of an apparatus shown in FIG. 3;

FIGS. 5(a) and 5(b) depict a process of extracting a selected area from an image-editing unit and storing the selected area in a selected-image-managing unit of an apparatus shown in FIG. 3;

FIG. 6 is a block diagram of a selected-image-managing unit shown in FIG. 5;

FIG. 7 is a block diagram of a layer-managing unit of an apparatus shown in FIG. 3;

FIG. 8 depicts a background color-determining unit in a layer-managing unit shown in FIG. 7;

FIG. 9 depicts a layer-flag-selecting unit in a layer-managing unit shown in FIG. 7;

FIG. 10 depicts a layer-state-storing/returning unit in a layer-managing unit shown in FIG. 7;

FIG. 11 is a block diagram showing an image-file-creating apparatus that automatically records metadata of an image in a document according to an example embodiment of the present invention;

FIGS. 12(a) and 12(b) depict a process of automatically inputting start coordinates in a document according to an example embodiment of the present invention;

FIGS. 13(a) and 13(b) depict a process of automatically inputting a color value in a document according to an example embodiment of the present invention;

FIGS. 14(a) and 14(b) depict a process of automatically inputting a height and width of an image in a document according to an example embodiment of the present invention;

FIGS. 15(a) and 15(b) depict a process of automatically inputting a filename in a document according to an example embodiment of the present invention;

FIG. 16 depicts a process of creating an image file according to an example embodiment of the present invention;

FIG. 17 depicts a process of correcting a value which is automatically recorded in an image and a position of a guide unit according to an example embodiment of the present invention;

FIG. 18 is a block diagram showing an image-file-creating apparatus to generate an image table according to an example embodiment of the present invention;

FIG. 19 depicts an image table according to an example embodiment of the present invention;

FIG. 20 is a block diagram showing an image-file-creating apparatus to generate an animation table and a flow diagram according to an example embodiment of the present invention;

FIGS. 21(a) and 21(b) depict an animation table and a flow diagram generated by an image-file-creating apparatus shown in FIG. 20;

FIG. 22 depicts an animation unit according to an example embodiment of the present invention;

FIG. 23 is a block diagram showing an image-file-creating apparatus which arranges and shows indicators in the same position according to an example embodiment of the present invention; and

FIG. 24 depicts a process of arranging indicators in the same position according to an example embodiment of the present invention.

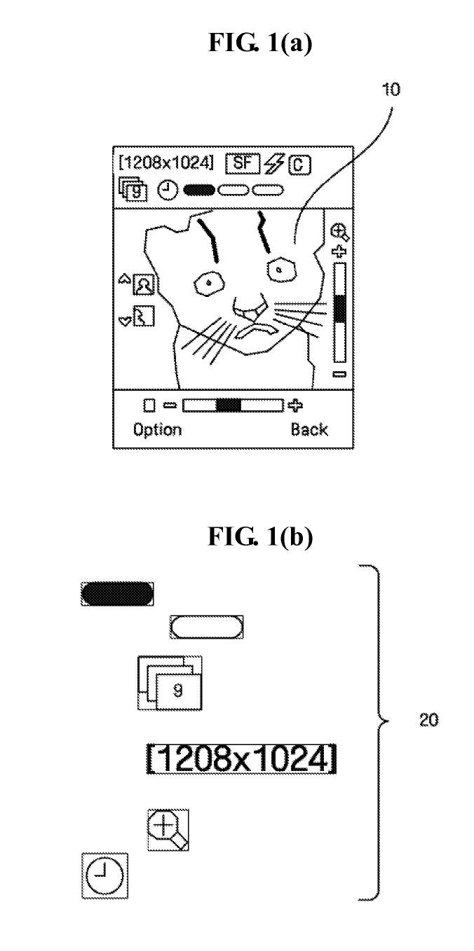

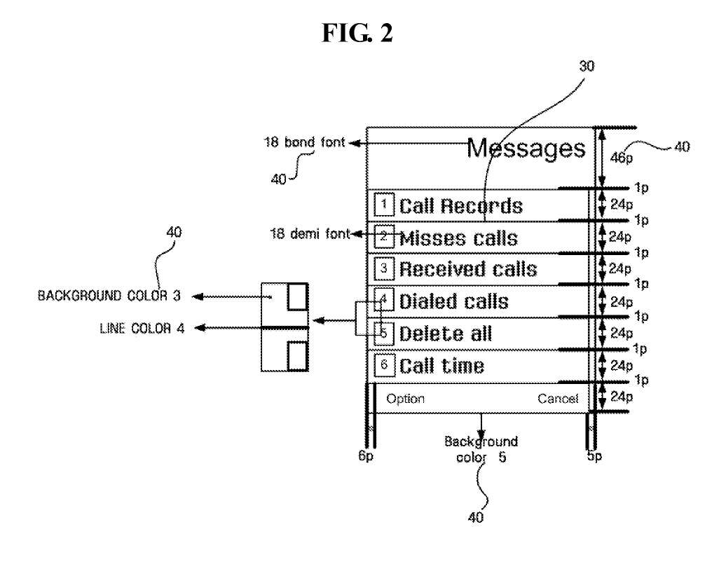

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

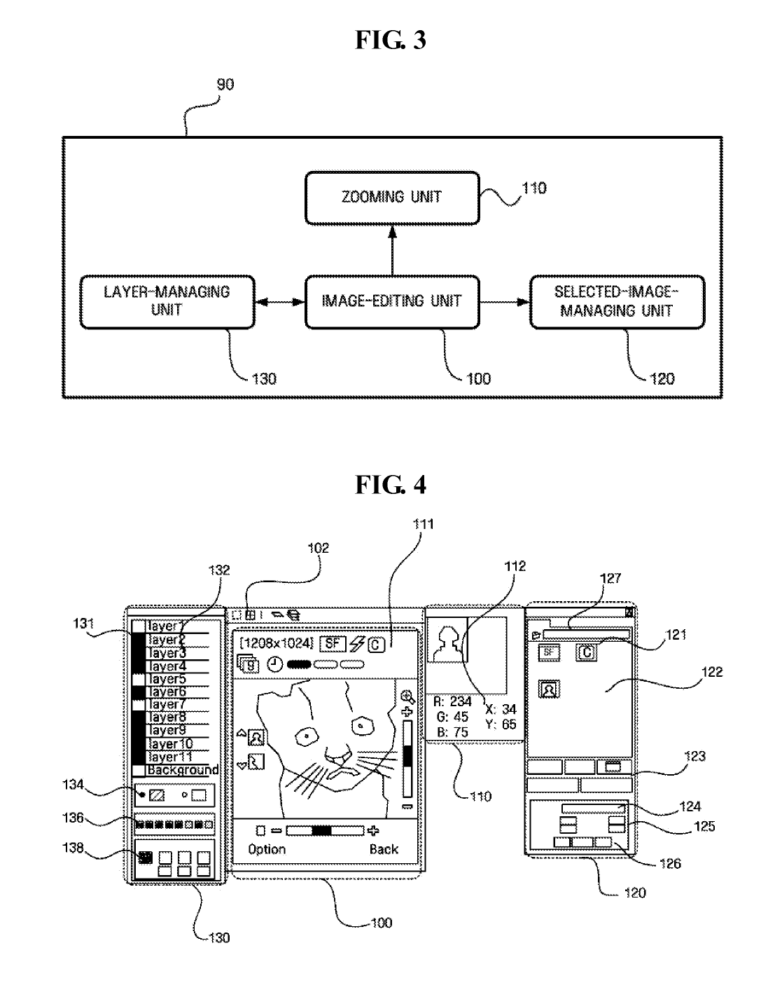

FIG. 3 is a block diagram of an apparatus 90 to collectively store areas selected in an image according to an example embodiment of the present invention. FIG. 4 depicts a user interface of an apparatus 90 shown in FIG. 3. As shown in FIGS. 3 and 4, the apparatus 90 to collectively store areas selected in an image includes an image-editing unit 100, a zooming unit 110, a selected-image-managing unit 120, and a layer-managing unit 130.

The term “unit”, as used herein, refers to, but is not limited to referring to, a software or hardware component, such as a Field Programmable Gate Array (FPGA) or an Application Specific Integrated Circuit (ASIC), which performs certain tasks. A module may advantageously be configured to reside in the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

The image-editing unit 100 loads an image file, displays the image file and enables a user to edit the image file. This image file is also referred to as a standard image file. A user may load the image file using the image-editing unit 100 by pulling down a file menu of a general document generator and clicking on a load command, by selecting the image using a mouse, or by other methods known in the art to select a file from a computer. When loading the image file, the image-editing unit 100 loads an image bit value, metadata of the image, and layer information of the image. The metadata includes various information about the image file, including, for example, a filename, an image size, and start coordinates which indicate a location of the image file relative to an entire image, also known as a standard image. The layer information includes various information about image layers in the image file, including, for example, a layer size, a layer state (whether a user has selected a layer) and a flag value (a value for grouping layers). The loaded image (image bit value) is displayed in an image-displaying unit 111, such as a computer screen, etc., and the layer information is displayed in the layer-managing unit 130.

The image-editing unit 100 includes a scroll function which a user may use to navigate around a screen on the image-editing unit 100, for example, to scroll up and down or left and right across the image if the screen of the image-editing unit 100 is smaller than the loaded image. Furthermore, a user can use the image-editing unit 100 to zoom into or away from the image for easy editing. The image-editing unit 100 may further include an input unit (not shown) which a user can use divide the image into areas, also known as sub-images, and select one or more of the areas. The input unit may be embodied as various devices known in the art, such as, for example, a computer mouse, a touch pen, a touch screen, arrow keys, etc, and may have a marker, such as an arrow, to navigate around a computer screen. A user may select a shape and/or size of the selected area in various ways, such, as for example, by drawing a rectangle on the screen around the desired image using the input unit. Further, the selected area is not limited to being selected as a rectangular area, and may instead be selected as various other shapes according to commands entered into the input unit, such as, for example, a circular shape, an elliptical shape, etc. Additionally, the input unit may be controlled to select an exact shape of the to-be-selected area. Predetermined lines, such as, for example, dotted line, may be used to trace out a shape of the selected area. Also, the color of pixels within the selected area may be changed using the input unit.

The image-editing unit 100 further includes a serial-selection-setting unit 102 that consecutively sets selected areas using the input unit. The image editing unit 100 enables a user to select an area after clicking an area-selecting menu (or icon) and then using a tool, such as, for example, a drawing tool, in the general document generator. Aspects of the present invention enable a user to select a plurality of areas using the area-selecting menu. The serial-selection-setting unit 102 may be used for various reasons, such as, for example, when using the area-selecting menu is not an efficient way to select areas. The serial-selection-setting unit 102 consecutively selects areas using the input unit because the area-selecting menu is available. The serial-selection-setting unit 102 may be embodied in various forms, such as, for example, the two icons illustrated in FIG. 4. The left icon, which is illustrated as a square, enables a user to select one area at a time, while the right icon, which is illustrated as a square divided into areas, enables a user to consecutively select areas to be divided and stored. It is understood that the serial-selection-setting unit 102 is not limited to selecting areas in a consecutive order, and may instead select areas based on a wide variety of sequences or patterns desired by a user.

If the area-selecting menu is cancelled, a user may modify the selected area. Also, when an area is not selected properly, the selected area indicated by the dotted line may be modified in various ways. For example, when an area is improperly selected by dragging a rectangular box over a portion of the entire image, also known as a standard image, the size of the area selected by the rectangle is increased or decreased by dragging an edge or corner of the rectangle. It is further understood that there may be various ways to select areas from within an image, and aspects of the present invention are not necessarily limited to using an input unit to select the areas. For example, designers may insert metadata which automatically sets an area as a selected area, and software developers may use some other sort of known computer programming device to designate an area as a selected area.

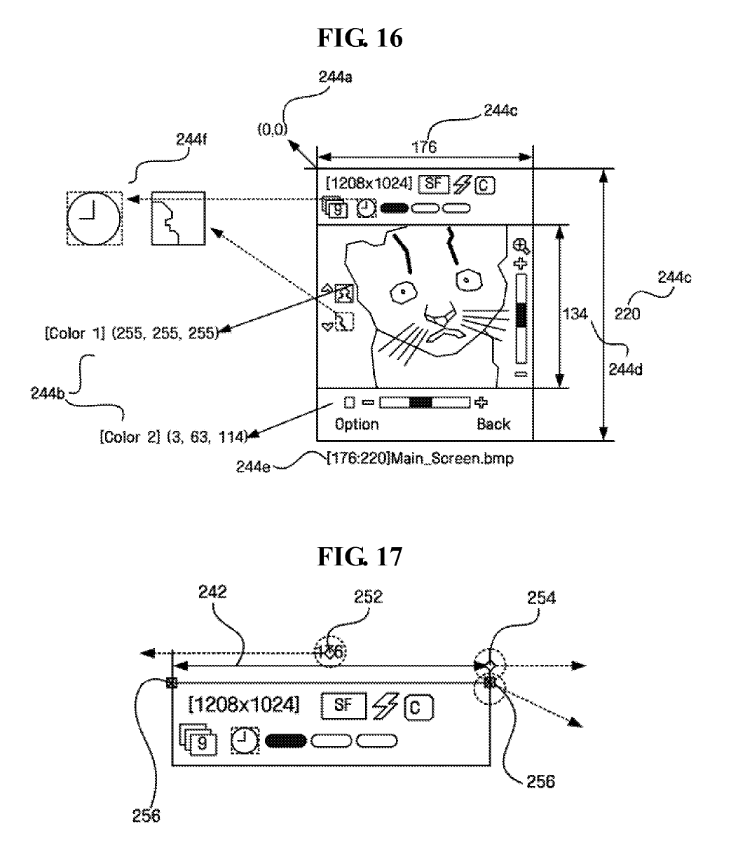

The zooming unit 110 zooms into and away from a position where the input unit is located on the image displayed by the image-editing unit 100. When selecting an area of a detailed size, the zooming unit 110 enables a user to precisely select the area. The zooming unit 110 includes an information-displaying unit 112 that displays predetermined information. The predetermined information may include, for example, a position of the input unit i.e., coordinates 244a (FIG. 16) of the input unit relative to edges of the screen, pixel value and color information 244b (FIG. 16) of the position where the input unit is located, and size information 244c (FIG. 16) of an area selected by the input unit. A user may then base his or her decision whether to select an area by recognizing the predetermined information of the area where the input unit is currently located by observing the predetermined information using the information-displaying unit 112. The information displaying unit 112 may be located at various places on the screen, and may be various sizes and shapes.

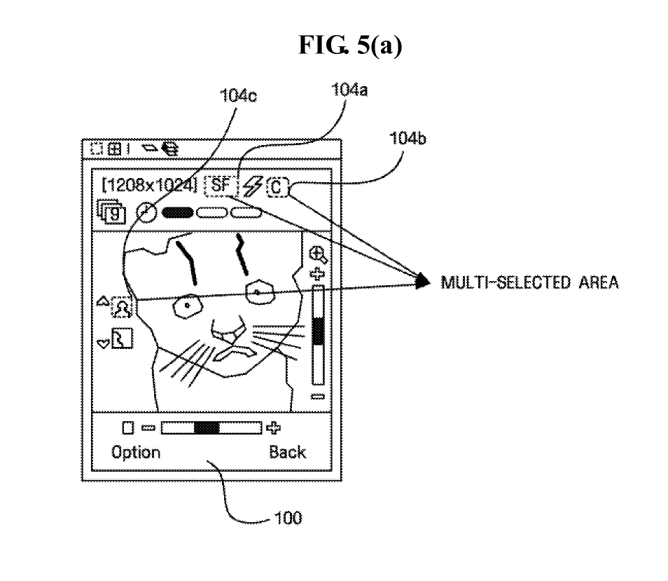

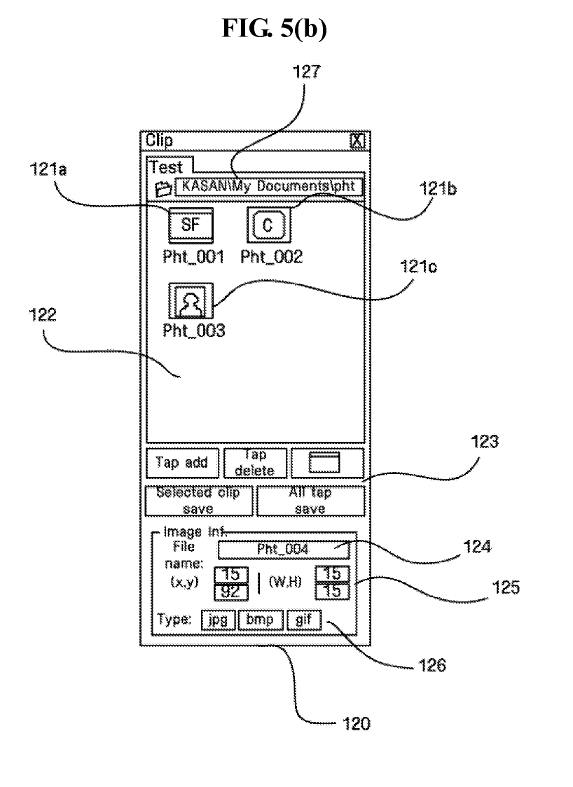

The selected-image-managing unit 120 extracts and collectively stores the area or areas selected by a user. FIGS. 5a and 5b depict a process of extracting a selected area from an image-editing unit 100 and storing the extracted area in a selected-image-managing unit 120 of an apparatus shown in FIG. 3. In the image-editing unit 100 shown in FIG. 5a, three areas 104a, 104b, and 104c are selected and extracted to the selected-image-managing unit 120 shown in FIG. 5b. The extracted areas 121a, 121b, and 121c, which respectively correspond to the three areas 104a, 104b, and 104c, are stored in the selected-image-managing unit 120 to be managed by a user. The selected areas 104a, 104b, and 104c may be extracted collectively or separately by the selected-image-managing unit 120.

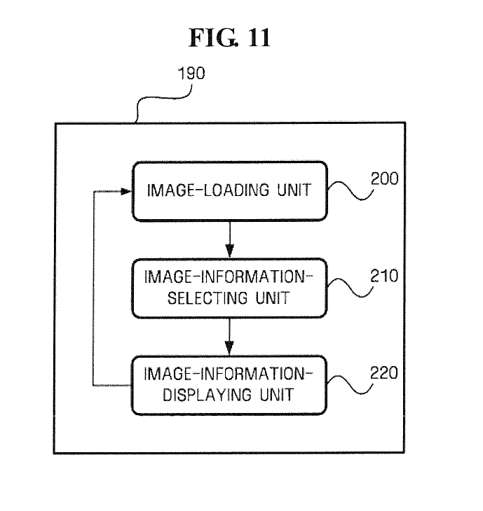

When the selected area is collectively stored in the selected-image-managing unit 120 as an image file, metadata of the image file is also stored. According to an aspect of the present invention, the metadata includes information related to coordinates 244a, for example start coordinates of the selected area based on the original image. The stored coordinate information 244a is used to determine a position where the selected image was located in the original image in an image-file-creating apparatus 190 (FIG. 11).

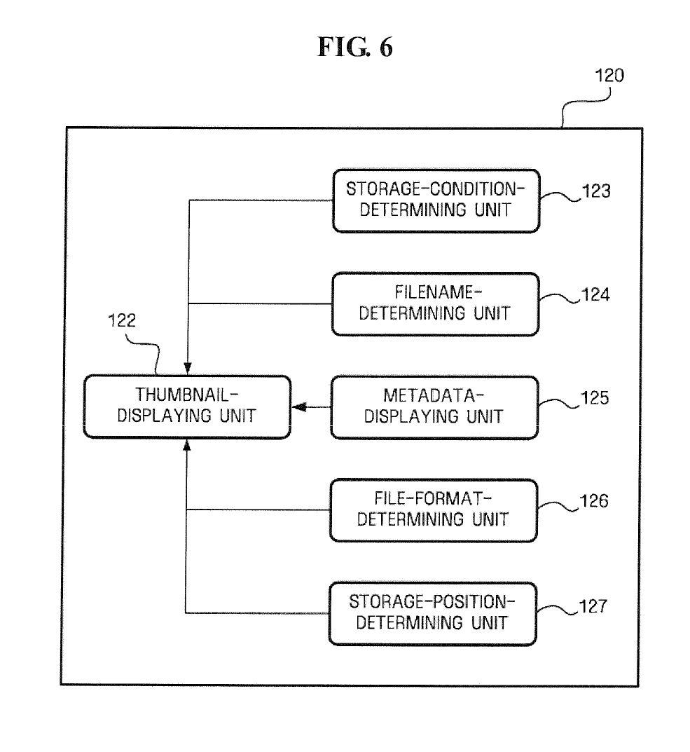

FIG. 6 is a block diagram of a selected-image-managing unit 120 shown in FIG. 5. The selected-image-managing unit 120 includes a thumbnail-displaying unit 122, a storage-condition-determining unit 123, a filename-determining unit 124, a metadata-displaying unit 125, a file-format-determining unit 126, and a storage-position-determining unit 127.

The thumbnail-displaying unit 122 displays an image of the selected area as thumbnails 121(a), 121(b), and 121(c) on a list window having a tab, as shown in FIG. 5. A user may classify the divided image by adding or deleting the tab. A name of the tab or a name input to the filename-determining unit 124 by a user may be displayed as a filename in each thumbnail 121. Also, the filename displayed in the thumbnail 121 may be separately modified. A user may classify the stored image by adding and using the tabs. A specific tab may be used to store and manage specific types of images, for example, a tab to store and manage images, a tab to store and manage logos, etc. Also, the thumbnails 121 located in the tab may be moved or copied to another tab.

The storage-condition-determining unit 123 determines whether all of the images displayed by the thumbnail-displaying unit 122 are collectively stored as image files, or whether only selected images displayed by the thumbnail-displaying unit 122 are collectively stored as image files. The storage-condition-determining unit 123 is represented by an icon in the lower right-hand side of the thumbnail-displaying unit 122, as shown in FIG. 5b.

The filename-determining unit 124 determines filenames of images when the images are collectively stored in the thumbnail-displaying unit 122. After the filename-determining unit 124 determines the filenames of images, the filenames are generated as names which include both a common filename and a unique serial number for each image file. For example, if the filename-determining unit 124 determines that the common filename is “indicator,” when images are collectively stored in the thumbnail-displaying unit 122, each filename is automatically set to “indicator01,” “indicator02,” “indicator03,” etc., corresponding to respective images. It is understood that the filename-determining unit 124 may label the image files in other ways, and is not limited to the method described above. The filename-determining unit 124 is represented by an icon below the icon representing the storage-condition-determining unit 123.

When the thumbnail-displaying unit 122 selects a specific thumbnail 121a, 121b, or 121c, the metadata-displaying unit 125 displays metadata defining an area corresponding to the specific thumbnail 121a, 121b, or 121c. For example, the metadata may indicate a position (coordinates 244a) and a size (height and a width information 244c) of the selected area. It is understood that the metadata may also describe other characteristics of the selected area instead of or in addition to the coordinates 244a and the width information 244c. The metadata-displaying unit 125 is represented by an icon below the icon representing the filename-determining unit 124.

The file-format-determining unit 126 sets a format of a stored file when the selected areas are collectively stored as an image file. For example, the file-format-determining unit 126 may set the format of the image file as .jpg, .gif, or .png. The file-format-determining unit 126 is represented by an icon below the icon representing the metadata-displaying unit 125.

The storage-position-determining unit 127 determines a position where each of the images located in each tab of the thumbnail-displaying unit 122 are stored as an image file. The storage-position-determining unit 127 is represented by an icon at a top of the thumbnail-displaying unit 122.

The apparatus 90 to collectively store selected areas of an image, as shown in FIGS. 3 and 4, may further include a layer-managing unit 130. The layer-managing unit 130 manages layers by showing layer information of images loaded from the image-editing unit 100. The layer, which is based on a concept used by various kinds of image-generating programs, such as, for example, Photoshop, refers to layers included within a two-dimensional image which is generated by overlapping the layers. Accordingly, this layer concept enables an image to be modified by modifying, adding and/or removing various layers within the two-dimensional image. The layer-managing unit 130 displays information about each of the layers included in a loaded image file as a list 132 (FIG. 4). The layer information includes information about a flag 131 of each layer, and whether each layer is in a selected or cancelled state. Aspects of the present invention add a function of managing layers.

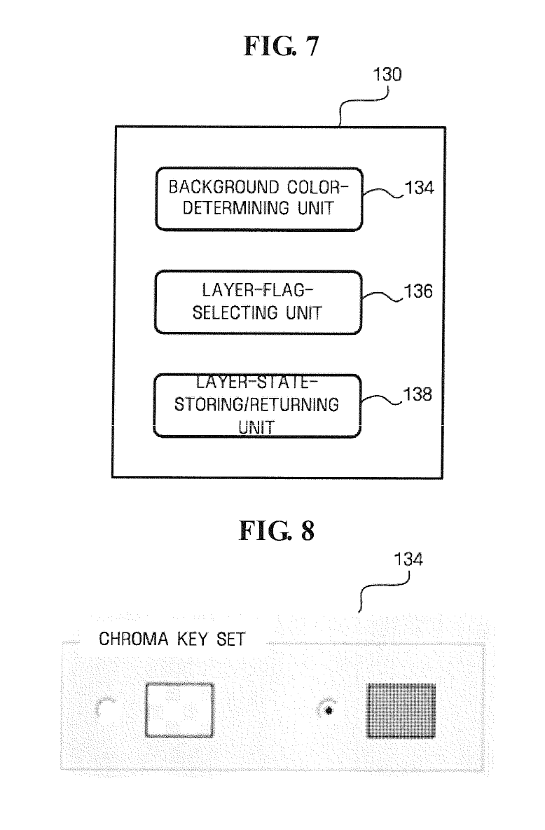

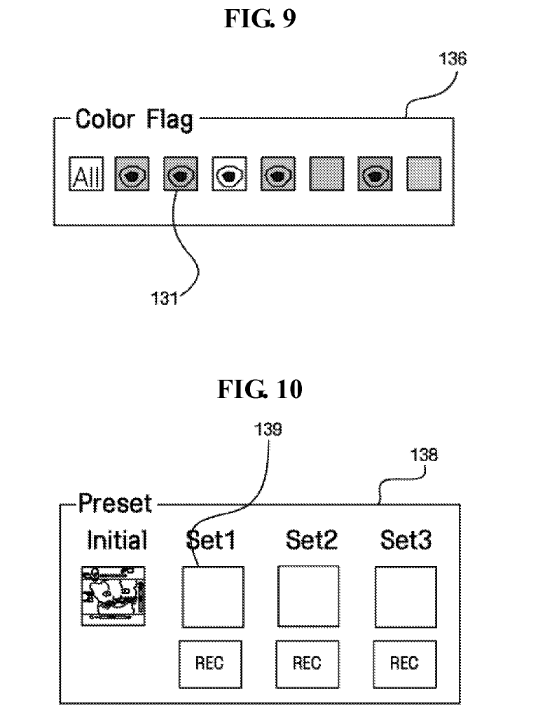

FIG. 7 is a block diagram of a layer-managing unit 130 of an apparatus shown in FIG. 3. FIGS. 8, 9, and 10 respectively depict a background color-determining unit 134, a layer-flag-selecting unit 136, and a layer-state-storing/returning unit 138. The layer-managing unit 130 shown in FIG. 7 includes the background color-determining unit 134 shown in FIG. 8, the layer-flag-selecting unit 136 shown in FIG. 9, and the layer-state-storing/returning unit 138 shown in FIG. 10.

The background color-determining unit 134 selectively adds an optional color into a colorless part of an image in a specific layer. When a designer draws an image in a specific layer, the remaining area not drawn on by the designer, which corresponds to the background color, should generally be transparent. However, when an image is sent to a developer, the image may be limited by a software development platform, so the transparent part of the image is often indicated as a specific color. In the past, a background color was represented by adding a layer corresponding to the background color and a layer corresponding to an image drawn by a designer. This conventional process was inefficient because designers needed to design a layer for the background color and a layer for the original image. However, the background color-determining unit 134 according to an aspect of the present invention enables a designer to determine a background color in the layer in which an image is drawn without the designer needing to design an additional layer corresponding to a background color, thereby simplifying the process which was previously required in the past. When the icon on the left of the background color-determining unit shown in FIG. 8 is selected, the background color is set to be colorless. When the icon on the right of the background color-determining unit shown in FIG. 8 is selected, the background color is changed to a specific color. Users may choose color values as well as a range of colors which the background may be set to.

When layers are grouped using the flag 131, the layer-flag-selecting unit 136 enables the grouped layer to be collectively selected or cancelled. The related layers are grouped using the flag 131. Each layer is grouped by flags 131 which are displayed in the layer list 132 shown in FIG. 4. If each layer is grouped with flags 131 having different colors, when the flag 131 having a specific color is selected, all layers indicated by the specific flag 131 in the layer list 132 are selected or cancelled at once. According to the selection or cancellation of the layer, the image displayed on the image-displaying unit 111 is displayed by the selected layer. It is understood that the image displaying unit 111 may be integrally combined with the information displaying unit 112 or provided separately from the information displaying unit 112.

The layer-state-storing/returning unit 138 stores information about whether a layer in the layer list 132 is selected or cancelled, stores a state of individual layers, and returns to the stored state of the individual layers. When designing an image, a designer often works on specific layer states. After storing several specific layer states, the designer designs an image by converting the layer states. When a REC button, such as one of the three REC buttons shown in FIG. 10, is selected, the select or cancel state of the current layer is stored and the image of the state of the layer is displayed as a thumbnail in a square box 139. When the thumbnail is selected after several layer states are stored, the layer is returned to the stored state. Thus, the layer-state-storing/returning unit 138 enables a designer to efficiently store and access layers.

An image-file-creating apparatus 190 will now be described. During the process of developing a GUI, a designer makes a document including metadata of the image (produced by the designer) and a requirement, and sends the document to a developer. The image-file-creating apparatus 190 enables the designer to conveniently create the document.

FIG. 11 is a block diagram showing an image-file-creating apparatus 190 that automatically records metadata of the image in an image file according to an example embodiment of the present invention. As shown in FIG. 11, the image-file-creating apparatus 190 includes an image-loading unit 200, an image-information-selecting unit 210, and an image-information-displaying unit 220.

The image-loading unit 200 loads an image file having metadata and displays an image based on the image file. The image can be loaded through a variety of methods known in the art, for example, by using a mouse to drag and drop an icon representing the image into a folder, by using a file-opening menu, or by selecting a file-opening icon in a document. As mentioned above, the image file is stored with metadata of the image. The image file may contain various types of metadata about the image, including metadata about positions (coordinates 244a) of each of the images within the standard image.

The image-information-selecting unit 210 selects the type of metadata displayed about the image. The metadata may include position information (coordinates 244a), color information of pixels 244b, height and width information 244c, and a filename of an image 244e. When a user clicks the right button of a mouse on an image, a dialogue box showing the type of the metadata is displayed, and the user can thus select the type of metadata to be input.

The image-information-displaying unit 220 automatically displays information about the metadata selected by the image-information-selecting unit 210. At this point, the information about the metadata is displayed using a guideline 242 which is illustrated as an arrow.

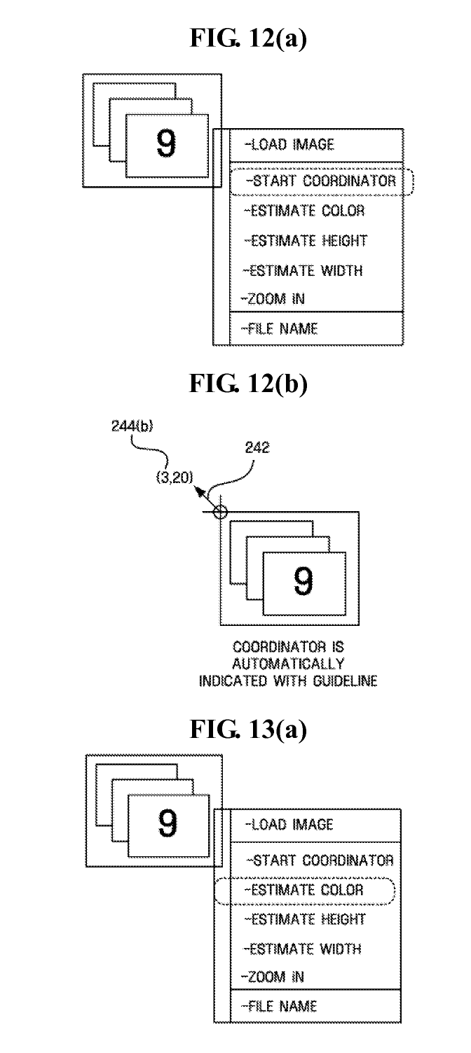

FIGS. 12(a) and 12(b), 13(a) and 13(b), 14(a) and 14(b), and 15(a) and 15(b) depict processes of automatically inputting coordinates 244a, color values 244b, height and width information 244c, and a filename 244e in a document, respectively, according to example embodiments of the present invention. In the process to automatically input start coordinates shown in FIGS. 12(a) and 12(b), a dialogue box is generated which enables a user to select the type of metadata to be input through various methods, such as, for example, by clicking the right button of a mouse in the dialogue box. When the coordinates 244a are selected in the dialogue box, the coordinates 244a are automatically generated. At this point, the guideline 242 is also input, which notifies a designer that the image includes the coordinates 244a.

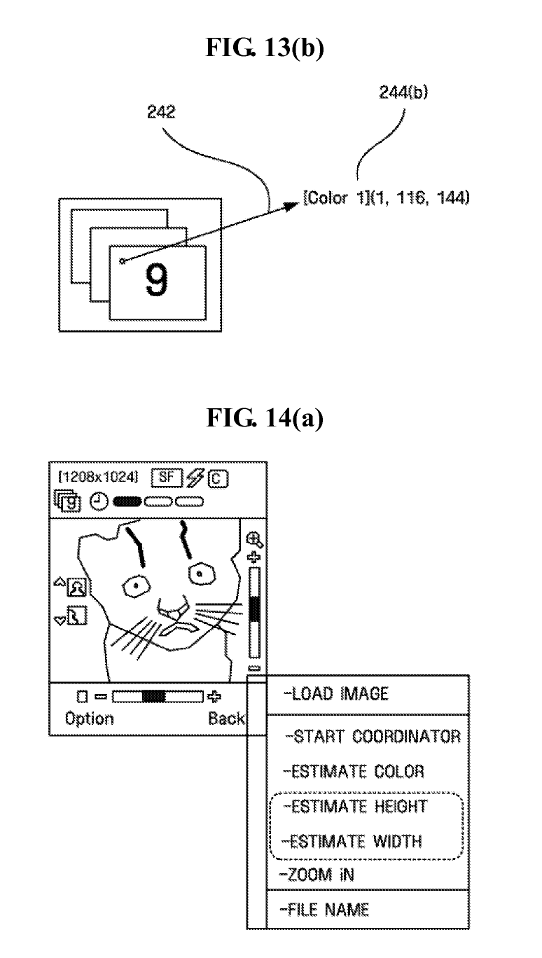

FIGS. 13(a) and 13(b) depict a process of automatically inputting a color value 244b of a specific position in the image. Here, the guideline 242 is generated. The guideline 242 loads the color value 244b, also known as a pixel value 244b, of the specific position from the image data, and automatically inputs the pixel value 244b.

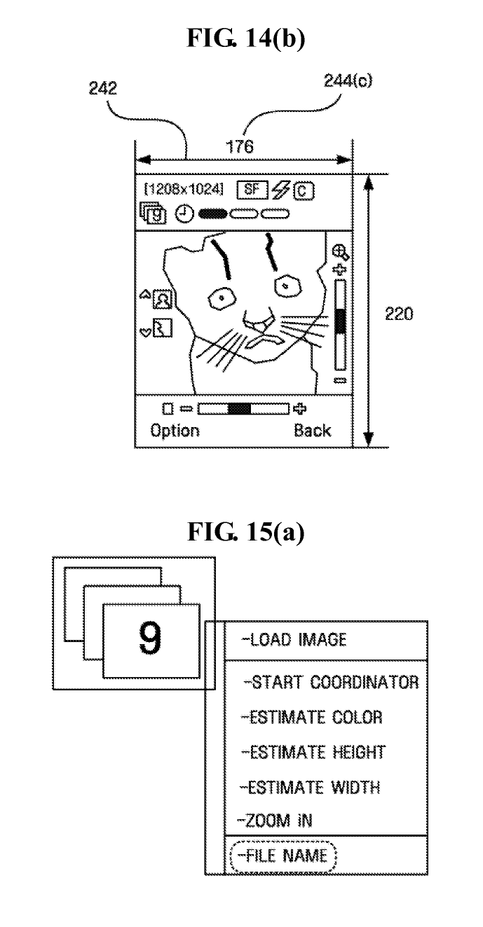

FIGS. 14(a) and 14(b) depict a process of automatically inputting height and width information 244c of an image. When a description of the image file is created, the size of the image is important information for the designers and the software developers. Thus, the size of the entire image or a space between specific points within the image should be displayed as important information. When a user selects height and width information 244c of the image, the width of the image, which in FIG. 14(b) is 176 units, is automatically input using the guideline 242. Similarly, the height of the image, which in FIG. 14(b) is 220 units, is automatically input using another guideline (not shown). Also, a position of the guideline 242 can be changed through a simple operation. According to this change, the input metadata is automatically updated, which will be described with reference to FIG. 17.

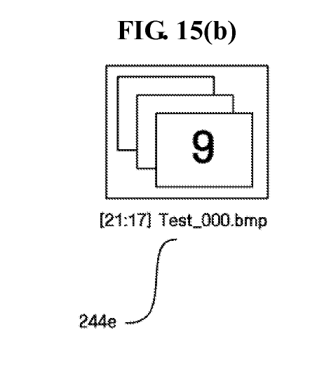

FIGS. 15(a) and 15(b) depicts a process of automatically inputting a filename 244e. When a user selects the filename 244e from the dialogue box, metadata about the filename 244e is automatically input to the document.

FIG. 16 depicts a process of creating an image file according to an example embodiment of the present invention. The image file includes, for example, the coordinates 244a, the color value 244b of a specific point, the height and width information 244c of an image, a length 244d between specific points in the image, the filename 244e, and an enlarged image 244f of a specific area. It is understood that the image file may include various other types of information as well.

FIG. 17 depicts a process of correcting a value that is automatically recorded in an image and a position of a guide unit. FIG. 17 shows a width of the image which is approximated by a length of the guideline 242. The guideline 242 is displayed as an arrow, but it is understood that the guideline 242 is not limited to being an arrow, and may instead be other visual representations. An estimating area and a position where the width value of the image is input can be changed. When the automatically input width value is selected, a display-controlling point 252 is displayed, which can be moved using an input unit, such as a mouse, arrow keys, etc., in order to change a position where the width value is input. By clicking and dragging a position-estimate-controlling point 254 located at a line indicating a boundary of one end of the guideline 242, a user can control a length of the guideline 242. As the user drags the position-estimate controlling point 254, the estimated changes in the length of the image are input and changed in real time. Furthermore, a user can easily move the position-estimate-controlling point 254 to a precise pixel position because the position-estimate-controlling point 254 moves by pixel units generated when the image file was generated. Also, a user can control a position and a length of the line indicating the boundaries of both edges of the guideline 242 by moving one of the guideline-position-controlling points 256 located at the edges of the guideline 242. Through the same clicking and dragging method, other image information, such as another auto-input color value and a filename, may also be input to a desired position by a user.

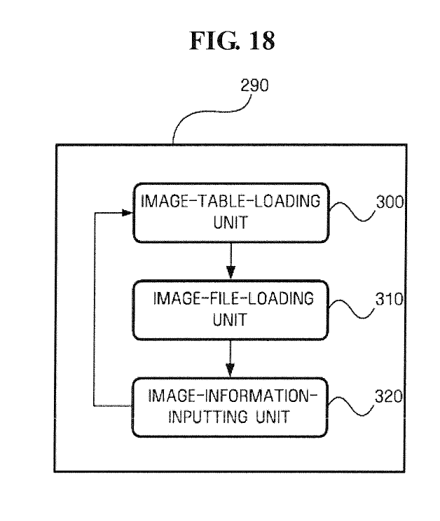

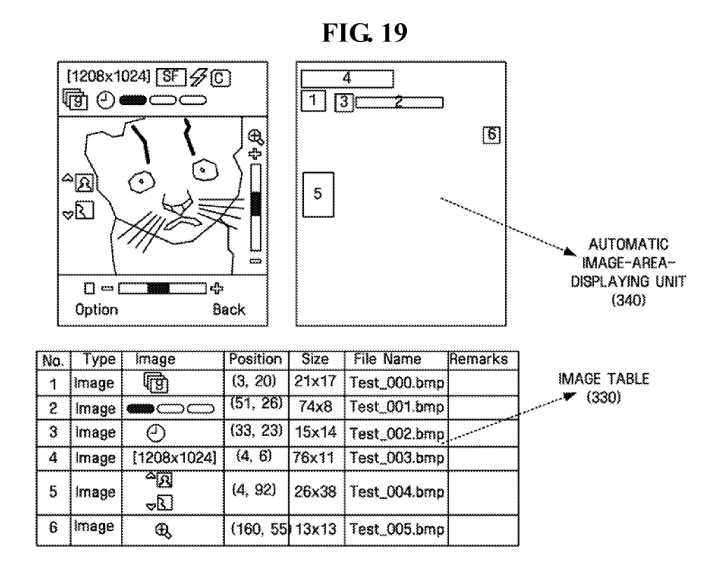

FIG. 18 is a block diagram showing an image-file-creating apparatus 190 which generates an image table according to an example embodiment of the present invention. FIG. 19 depicts an image table 330 according to an example embodiment of the present invention.

The image-file-creating apparatus 190 includes an image-table-loading unit 300, an image-file-loading unit 310, and an image-information-inputting unit 320. The image-table-loading unit 300 loads the image table 330 where metadata will be recorded. Initially, the image table 330 has no metadata recorded in any of the cells. The image table 330 is generated and input into a document by clicking on a command from a menu, by clicking on an icon, or by manually designing a table shape using a tool that draws a basic table shape by dragging and dropping on an icon using a mouse arrow.

The image-file-loading unit 310 loads an image file that has metadata information to be input in the image table 330. When the image table 330 is generated in a document, a dialogue box that loads an image file automatically or by selecting a specific cell within the image table 330 can be generated. One or more image files are selected in the dialogue box, which are inserted into the image table 330.

The image-information-inputting unit 320 automatically inputs metadata of each image file selected by the image-file-loading unit 310 to each cell of the image table 330. Here, predetermined metadata is input in a specific line or row of the image table 330. The input metadata may be various types of information, including, for example, position information 244a, color values 244b, width and height information 244c, a file format (e.g., .jpg, .gif, or .png), and a filename 244e. Also, the image-information inputting unit 320 displays the image of the loaded image file, as shown in FIG. 19.

Referring to the image table 330 shown in FIG. 19, each line includes columns of information corresponding to a number, a file type, an image, start coordinates 244a, height and width information 244c, and a filename 244e, which are recorded for each file. Accordingly, aspects of the present invention efficiently generate an image table 330 in which information related to images is recorded using a table format, in contrast to the inefficient recording method used to record information in the conventional art.

Aspects of the present invention further include an automatic image-area-displaying unit 340 that graphically displays a position and a size of a loaded image file based on the standard image designated by a user. The automatic image-area-displaying unit 340 graphically displays each image recorded in the image table 330, and is especially useful when the images in the table are extracted from a single image (i.e., the images are divided from the same image, as shown in FIG. 19). The upper-left figure of FIG. 19 is referred to as the standard image. When a user loads an image and sets the loaded image as the standard image, the automatic image-area-displaying unit 340 graphically displays an area corresponding to each image recorded in the image table 330 in positions corresponding to the positions of the images relative to each other in the standard image, as shown in FIG. 19. Areas of each image are displayed according to shapes of the actual images in the standard image, and the image number recorded in the image table 330 for each of the images is displayed in the automatic image-area-displaying unit 340.

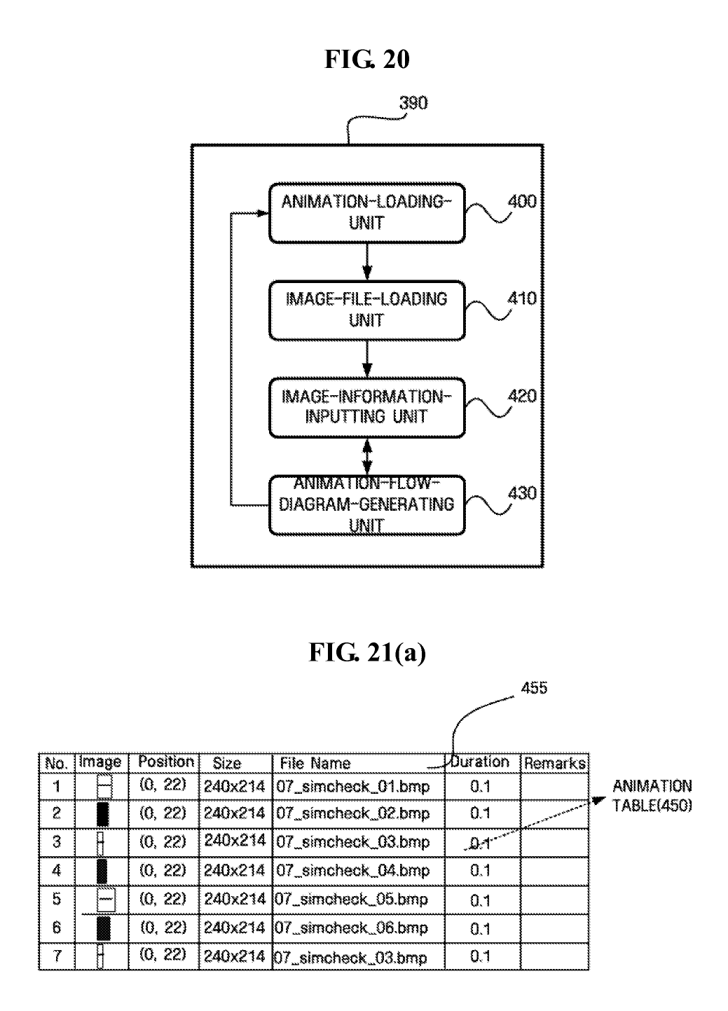

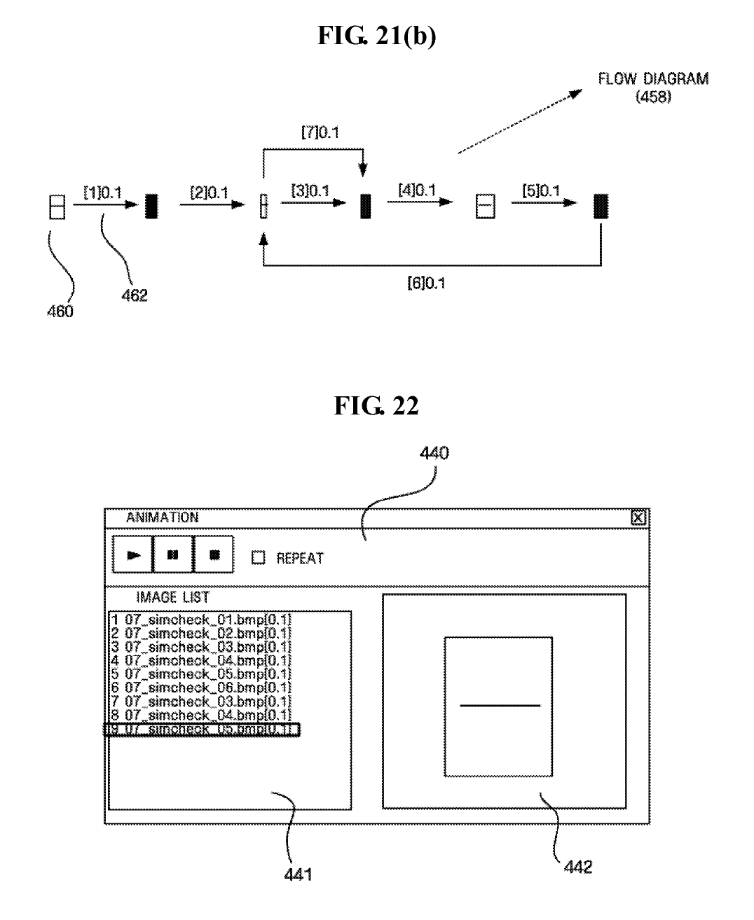

FIG. 20 is a block diagram showing an image-file-creating apparatus 390 which generates an animation table 450 (FIG. 21) and a flow diagram according to an example embodiment of the present invention. FIGS. 21(a) and 21(b) respectively depict the animation table 450 and a flow diagram according to an example embodiment of the present invention. The image-file-creating apparatus 390 includes an animation-table-loading unit 400, an image-file-loading unit 410, an image-information-inputting unit 420, and an animation-flow-diagram-generating unit 430.

The animation-table-loading unit 400 loads the animation table 450, where metadata of each image and a display time of each image are recorded. The animation table 450 may be recorded in a document using the same method that loads the aforementioned image table 330, or may be recorded in a document using a different kind of method.

The image-file-loading unit 410 loads a to-be-recorded image file in the animation table 450. When the animation table 450 is generated in a document, a dialogue box that loads an image file automatically or by selecting a specific cell within the image table is generated. The animation table 450 displays thumbnail versions of each of the loaded image files. A user may then select one or more of the image files loaded in the dialogue box, and these selected image files are then loaded into the animation table.

The image-information-inputting unit 420 automatically inputs metadata of each image file selected by the image-file-loading unit 410 to cells of the animation table 450. Predetermined metadata is input in a specific line or row of the animation table 450. The input metadata may include various types of information, such as, for example, position information 244a, width and height information 244c, a file format (e.g., .jpg, .gif, or .png), and a filename 244e. The image of the loaded image file is displayed in the animation table 450. The display time of each image file is input when the animation is played. A specific value is input as a basic value and a user can change the animation by controlling the value. The animation table 450 shown in FIG. 21(a) is different from the image table 330 shown in FIG. 19 because the animation table 450 shown in FIG. 21(a) has a row 455 in which the display time (i.e., duration) of each image file is recorded.

The animation-flow-diagram-generating unit 430 automatically generates a flow diagram 458, illustrated in FIG. 21(b), using the animation table 450. The animation flow diagram 458 displays an order in which animation is played. The images 460, which each illustrate one frame in the animation, are arranged in a predetermined order, and arrows 462 connect each image in order to indicate a display time of the frames. A user may modify the display time on the arrow 462 to modify the time which the image corresponding to the arrow 462 is displayed. A user may directly generate the animation flow diagram 458 by generating arrows 462 which create a flow diagram shape indicating the order in which the frames should be displayed. After a user loads the shape indicating the order in which the frames should be displayed, the user loads images. The animation flow diagram 458 is generated by connecting each frame using the arrows 462 to form the flow diagram shape and by inputting display times corresponding to the arrows 462.

Aspects of the present invention further include a simulation unit 440 to reproduce real animation from the animation table 450 or to display the animation flow diagram 458. A list of the simulated files is displayed in an order, such as, for example, the order displayed on the left window 441 of the simulation unit 440 shown in FIG. 22. When the file is executed, the animation is simulated on the right window 442. It is understood that the simulation unit 440 can generate not only the animation flow diagram 458 from the animation table 450, but can also generate the animation table 450 from the animation flow diagram 458 automatically.

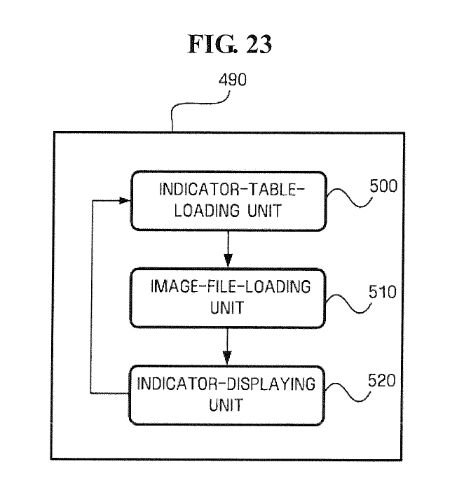

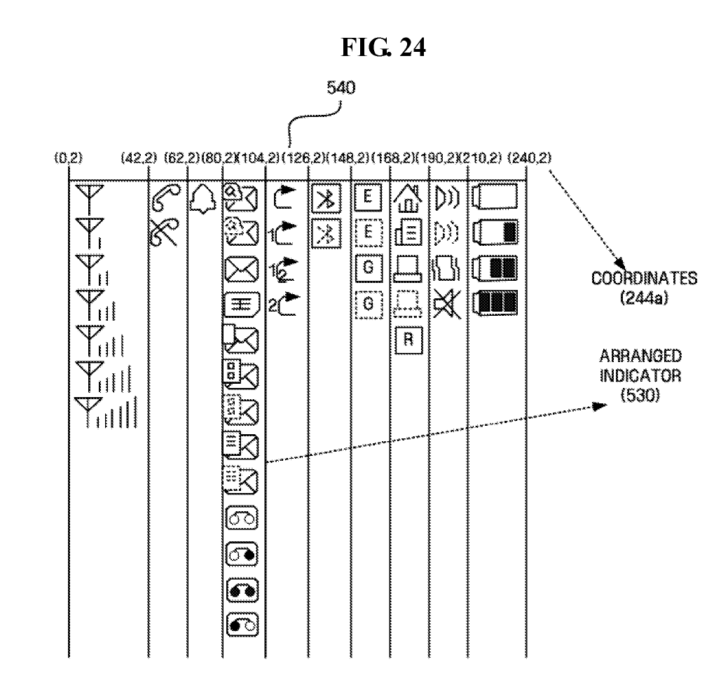

FIG. 23 is a block diagram showing an image-file-creating apparatus 490 that arranges and displays indicators 530 located in the same position according to an example embodiment of the present invention. FIG. 24 depicts a process of arranging the indicators 530 which are located in the same position according to an example embodiment of the present invention. The image-file-creating apparatus 490 includes an indicator-table-loading unit 500, an image-file-loading unit 510, and an indicator-displaying unit 520.

The indicator-table-loading unit 500 loads an indicator table 540 which arranges and displays images which are located in the same position, but which change according to circumstances. For example, as shown in FIG. 24, the reception signals in the left-hand column of the indicator table 540 are all located at the position (0,2), but these reception signals change appearances according to reception strength. The indicator table 540 is recorded in a document using a menu, an icon, or a shape like the aforementioned method of loading the image table 330.

The image-file-loading unit 510 loads image files in the indicator table 540. When the indicator table 540 is generated in the document, a dialogue box loads an image file automatically, or a user may load the image file manually by selecting a specific cell within the indicator table 540. One or more image files may be selected in the dialogue box, which are then loaded into the indicator table 540.

The indicator-displaying unit 520 arranges images having the same value by comparing coordinates 244a and sizes (i.e., width and height information 244c) of an image among metadata of each image file selected by the image-file-loading unit 510, and automatically inputs the images to each cell of the indicator table 540. The indicator-displaying unit 520 records the coordinates 244a in the arranged image, as shown in FIG. 24. All the images arranged below the position where the coordinates 244a are input, i.e., in the same column, have the same coordinates 244a and height and width information 244c. Thus, the generated indicator table 540 enables a user to easily access and use icons which are located in the same positions 244a of the entire image.

As described above, the apparatus 90 to collectively store areas selected in an image and the image-file-creating apparatuses 190, 290, 390, and 490 according to aspects of the present invention achieve one or more of the following effects. First, users can collectively store a plurality of areas extracted from an image, which creates a more efficient image dividing and storing process. When the images divided from the original image are stored, coordinates 244c and other image information is stored as metadata, which can be conveniently used when an image file is created. Furthermore, it is possible to efficiently and easily control image layers within the images. Also, when a user creates an image file by recording image information, aspects of the present invention enable the user to automatically input the image information to a document, thereby making the process of designing graphical user interfaces more efficient.

Various components of the apparatus 90 shown in FIG. 3, such as the layer-managing unit 130, the image-editing unit 100, and the selected-image-managing unit 120, along with components in any of the apparatuses 190, 290, 390, and 490, shown in FIGS. 11, 18, 20, and 23, respectively, can be integrated into a single control unit, or alternatively, can be implemented in software or hardware, such as, for example, an application specific integrated circuit (ASIC). As such, it is intended that the processes described herein be broadly interpreted as being equivalently performed by software, hardware, or a combination thereof. As previously discussed, software modules can be written, via a variety of software languages, including C, C++, Java, Visual Basic, and many others. These software modules may include data and instructions which can also be stored on one or more machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs). Instructions of the software routines or modules may also be loaded or transported into the wireless cards or any computing devices on the wireless network in one of many different ways. For example, code segments including instructions stored on floppy discs, CD or DVD media, a hard disk, or transported through a network interface card, modem, or other interface device may be loaded into the system and executed as corresponding software routines or modules. In the loading or transport process, data signals that are embodied as carrier waves (transmitted over telephone lines, network lines, wireless links, cables, and the like) may communicate the code segments, including instructions, to the network node or element. Such carrier waves may be in the form of electrical, optical, acoustical, electromagnetic, or other types of signals.

In addition, the present invention can also be embodied as computer readable codes on a computer readable recording medium. The computer readable recording medium is any data storage device that can store data which can be thereafter read by a computer system. Examples of the computer readable recording medium also include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While there have been illustrated and described what are considered to be example embodiments of the present invention, it will be understood by those skilled in the art and as technology develops that various changes and modifications may be made, and equivalents may be substituted for elements thereof without departing from the true scope of the present invention. Many modifications, permutations, additions and sub-combinations may be made to adapt the teachings of the present invention to a particular situation without departing from the scope thereof. Alternative embodiments of the invention can be implemented as a computer program product for use with a computer system. Such a computer program product can be, for example, a series of computer instructions stored on a tangible data recording medium, such as a diskette, CD-ROM, ROM, or fixed disk, or embodied in a computer data signal, the signal being transmitted over a tangible medium or a wireless medium, for example microwave or infrared. The series of computer instructions can constitute all or part of the functionality described above, and can also be stored in any memory device, volatile or non-volatile, such as semiconductor, magnetic, optical or other memory device. Furthermore, the software modules as described can also be machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs). Accordingly, it is intended, therefore, that the present invention not be limited to the various example embodiments disclosed, but that the present invention includes all embodiments falling within the scope of the appended claims.

What is claimed is:

1. An image-file-creating apparatus comprising:
an animation-table-loading unit to load metadata of one or more images and an animation table where a display time of the one or more images is recorded;
an image-file-loading unit to load one or more image files which correspond to the one or more images and which include the metadata of the one or more images; and
an image-information-inputting unit to input the metadata of the one or image files in cells of the animation table.

2. The apparatus of claim 1, further comprising:
an animation-flow-diagram-generating unit to automatically generate an animation flow diagram using the animation table.

3. The apparatus of claim 1, wherein the metadata for each of the one or more images comprises at least one of position information indicating a position of the image in relation to a standard image from which the image is extracted from, color information, a width of the image, a height of the image, and a filename of the image.

4. The apparatus of claim 1, wherein the animation table displays the one or more images corresponding to the one or more loaded image files.

5. The apparatus of claim 2, wherein the animation flow diagram displays the one or more images in an order, connects each of the one or more images to at least one other of the one or more images using an arrow, and indicates a display time of each of the one or more images on the arrow.

6. The apparatus of claim 1, further comprising:
an animation-table-generating unit to automatically generate the animation table using an animation flow diagram.

7. The apparatus of claim 2, further comprising:
a simulation unit to display animation played from the animation table or the animation flow diagram.
